(19) United States
(12) Patent Application Publication
(10) Pub. No.: US 2011/0251328 A1
(43) Pub. Date: Oct. 13, 2011

(54) Silyl-Based Antistatic White Coating

(76) Inventors: Stephanie Remaury, Auriac-sur-Vendinelle (FR); Pascale Nabarra, Baziege (FR); Olivier Guillaumon, Saint-Leon (FR); Serge Reymond, Verniolle (FR)

(21) Appl. No.: 13/083,488

(22) Filed: Apr. 8, 2011

(30) Foreign Application Priority Data
Apr. 8, 2010 (FR) 10 52674

(51) Int. Cl. C09D 183/04; C08K 3/22

(52) U.S. Cl. 524/432

(57) ABSTRACT

An antistatic white paint suitable for application on spacecraft notably, based on a binder of the silicon polymer type.

### CROSS REFERENCE TO RELATED APPLICATION

This application claims the benefit of the filing date of French patent application no. 10 52674, filed on Apr. 8, 2010, which is incorporated herein by reference in its entirety.

### BACKGROUND OF INVENTION

The present invention relates to electrically conducting coatings for anti-static protection of dielectric or metal substrates, notably of spacecraft, and in particular launchers and satellites. These coatings should meet several requirements. First of all, it is important to avoid charge accumulation at the surface. Therefore anti-static paints are sought for avoiding these so-called “flash-over phenomena” (electrostatic charges at the surface).

Moreover, these coatings should participate in the thermal control of the craft. It is therefore important that the paint be white, in order to allow total reflection of solar radiations and to avoid heating of the craft which may result from this.

Thus, these paints should meet very strict specifications in terms of solar absorption (alpha), of infrared emissivity (epsilon), of surface electric resistance and adherence.

In the FR 2 568 577 application, a pigment of tin oxide doped with antimony oxide is described as well as paints containing it, notably allowing removal of electrostatic charges. Nevertheless said colored pigment should be mixed with a white pigment in order to meet the requirements of low solar absorption. Moreover, this pigment is expensive and no longer meets European environmental standards. A paint based on tin oxide and on antimony oxide is also described in FR 2 668 491. Nevertheless, there again, addition of titanium dioxide is required for making the paint white.

U.S. Pat. No. 3,538,022 describes a method for making zinc oxide doped with aluminum, gallium or indium oxide.

U.S. Pat. No. 5,312,614 also describes the production of a white pigment based on zinc oxide, doped with gallium oxide, said pigment being white and electrically conducting.

Nevertheless none of these documents describes a paint containing such a pigment, notably a paint for space applications meeting the aforementioned technical requirements.

### SUMMARY OF INVENTION

Therefore an object of the invention is to provide an antistatic white coating suitable for application onto spacecraft, notably.

According to a first object, the invention therefore relates to a composition comprising a base component and a hardener component, such that the base component comprises at least one pigment based on zinc oxide doped with gallium oxide, a binder of the polymer type based on silicon, a solvent of this binder, and the hardener component comprises at least one hardener.

### DETAILED DESCRIPTION

Said binder may notably be selected from:
polysiloxanes R′₃SiO(R₂SiO)ₙSiR′₃ wherein R and R′ may be a group of the methyl, vinyl, phenyl, epoxy, hydroxyl, alkoxy, hydride or halogenated type and n a digit or number from 1 to 10,000. For example, mention may thus be made of notably polydimethylsiloxanes ([SiO(CH₃)₂]ₙ),and more particularly polydimethylsiloxanes with a silanol termination. Thus, polydimethylsiloxanes termination having a viscosity of from 16 to 100,000 cSt, notably from 5,000 to 50,000 cSt. are particularly suitable for the coating according to the invention. Thus, it is possible to notably mention as examples, polydimethylsiloxanes with a silanol termination, DMS-535®, DMS-542® and DMS-545® marketed by GELEST. Of course, other polydimethylsiloxanes with silanol termination known to one skilled in the art are also suitable. The polysiloxanes may account for 0 to 90% by weight of the base component; and/or
silicone polymer resins, such as polymer resins of the MQ, MDG, MD, MT type notably bearing methyl, vinyl, phenyl, expoxy, hydroxy, alkoxy, hydride or halogenated groups. The resins may account for 0 to 90% by weight of the base component; and/or
mixtures thereof.

Preferentially, said binder comprises at least one polydimethylsiloxane with a silanol termination.

As a solvent, it is possible to use, as an indication, aromatic hydrocarbons (toluene, xylene, styrene, naphtha etc), aliphatic hydrocarbons (white spirit, gasolines, petroleum, etc.,) ketones (methylethylketone, methylisobutylketone, diacetone, alcohol, etc.), esters, (ethyl acetate, methyl acetate, propyl acetate, ethylene glycol acetate, methylene glycol acetate etc.), glycol ethers (ethylglycol, butylglycol, methylene glycol, propylene glycol, etc.), alcohols (ethanol, propanol, methanol, etc.), aliphatic alkanes such as n-heptane and aromatic alkanes, esters, ketones, siloxanes with low molecular weights notably terpene hydrocarbons (turpentine, etc.), and water. More particularly, mention may be made of water, aliphatic and aromatic alkanes, esters, ketones, siloxanes with low molecular weight and notably hexamethyldisiloxane, octamethyltrisiloxane and octamethylcyclotetrasiloxane.

The solvent proportion may range up to 60% by weight of the base component.

The pigment is preferentially zinc oxide (ZnO) doped with Ga₂O₃, generally with 1-5%, preferentially 1-2% (by weight) of Ga₂O₃. The pigment according to the invention may be prepared by applying or adapting any method known per se such as notably by a temperature treatment and under a reducing atmosphere, notably the method described in U.S. Pat. No. 3,538,022 or U.S. Pat. No. 5,312,614. The ZnO/Ga₂O₃ pigment is generally used in dispersed or milled form.

The pigment may also comprise any other white pigment such as TiO₂, ZnO, in proportions between 0 and 75% by weight.

Said hardener may be selected from:
polysiloxanes R′₃SiO(R₂SiO)ₙSiR′₃ wherein R and R′ may be a group of the methyl, vinyl, phenyl, epoxy, hydroxy, alkoxy, hydride or halogenated type and n a digit or number of from 1 to 10,000, the polysiloxanes are comprised between 0 and 90% by weight of the hardener component;
siloxane monomers, oligomers or polymers, mono-, di-, tri- or quadri-substituted with hydroxyl, alkoxy, hydride, epoxy or vinyl groups; and/or
mixtures thereof.

Preferentially, the hardener is selected from at least one siloxane monomer, oligomer or polymer, mono-, di-, tri- or quadri-substituted with hydroxyl, alkoxy, hydride, epoxy or vinyl groups, and notably from alkoxysiloxanes such as triethoxysilane, methyltriethoxysilane, methyltrimethoxysilane, ethyltriethoxysilane, isopropyl-trimethoxysilane, isopropyltriethoxysilane, n-butyltrimethoxysilane, isobutyl-trimethoxysilane, phenyltrimethoxysilane, n-phenylaminopropyltrimethoxysilane, 3-(meth)acryloxypropyltriethoxysilane, 3-aminopropyltriethoxysilane, 3-mercaptopropyl-trimethoxysilane, polydiethoxysilane and fluoropropyltriethoxysilane, or a methylhydromethylsiloxane copolymer with a trimethylsiloxy termination.

The hardener component may also further comprise a retardant and/or a solvent.

The hardener component may also further comprise a retardant, for example, of the vinylsiloxane type (such as 1,3-divinyltetramethylsiloxane), or of the polyvinylsiloxane type (such as 1,3,5,7-tetravinyl-1,3, 5,7-tetramethylcyclosiloxane).

The hardener component may also comprise a solvent, for example, selected from water, aliphatic and aromatic alkanes, ester, ketones, siloxanes with a low molecular weight, and mixtures thereof.

The base component and/or the hardener component may optionally further comprise a catalyst. Said catalyst may be selected from any catalyst used for promoting cold or hot reactions, such as derivatives of platinum, titanium or tin, notably tin dibutyldiacetate. The catalyst may be comprised in an amount of 0 to 10% by weight of the base component. Generally, the catalyst is added in such an amount that the catalyst:binder (weight) ratio is less than 0.5%, preferentially comprised between 0.1 and 0.2%.

Generally, the weight ratio of the base:hardener components is comprised between 1 and 100.

The hardener:binder ratio is generally comprised between 10 and 70% (by weight). Generally, the amount of hardener may be adapted depending on the level of reactive functions in the base and the hardener.

Generally, the compositions according to the invention are such that the pigment:binder ratio is comprised between 1 and 7 (by weight). Preferably, said pigment:binder weight ratio is comprised between 1 and 4, even more preferentially between 1 and 2.

Without however being bound by theory, the inventors have identified that the pigment:binder ratio notably gave the possibility of adjusting the adherence and electric resistance properties of the composition. Thus, when this ratio increases, the adherence of the composition decreases. Conversely, when this ratio decreases, electric resistance increases.

Of course, the compositions of the invention may also comprise in the base and/or the hardener components, any desired adjuvants commonly used in formulations of coatings, of course provided that they do not excessively degrade the aforementioned technical specifications. Thus, for example, mention may be made of flow agents and adjuvants with which the adherence, coverage, drying or preservation performances may notably be improved. The proportion of these agents may vary between 0.5 and 25% (by weight) of the total composition.

According to another object, the invention also relates to the method for preparing a composition according to the invention.

The method comprises the preparation of the base component by mixing its constituents on the one hand, and the preparation of the hardener component, by mixing its constituents on the other hand.

According to another object, the present invention also relates to the method for preparing a coating comprising the mixture of the base and hardener components of a composition according to the invention.

This mixture consists of mixing the base component and the hardener component. This is usually accomplished with manual or mechanical stirring.

The type of equipment and the tooling, as well as the shear rate, may be adapted by one skilled in the art according to customary practices in order to obtain a homogeneous dispersion favorable for obtaining a conducting film.

The present invention also relates to the coating able to be obtained in this way.

The coating according to the invention notably satisfies the following specifications required for spacecraft, i.e.:
a solar absorptivity factor a of less than or equal to 0.3;
an infrared emissivity c of more than or equal to 0.8;
a surface electric resistance comprised between 1 and 1,000 MΩ/□ according to the ASTMD 257-97 or -98, -99 standard or ASTM D257-07 standard, as measured at atmospheric pressure or in a primary vacuum (10⁻³ torrs);
an adherence of class 0 or 1 out of 5, preferably 0, according to the NFEN ISO2409 standard (classification 30-038);
the paints for satellites should moreover have low degassing in vacuo (ESA ECSS-Q-70-02A standard) and radio transparence in a band of frequencies ranging from a few kHz to 20 GHz, such that the attenuation of the signal due to the coating does not exceed −0.1dB.

The coatings according to the invention may have a viscosity comprised between AFNOR cut No. 6 10-30 s or AFNOR cut No. 4 10-30 s. They generally have a flow behavior of the Newtonian or thixotropic type.

According to another object, the present invention also relates to the substrates coated with a coating according to the invention. Said substrates are generally any metal or dielectric support requiring such a coating, notably in the aeronautical, aerospace, military fields, photovoltaic, electric and chemical fields.

The coating of the invention may be applied on any kind of substrates such as polyimides, composites of polyimides or of epoxides reinforced with glass fibers, aramide fibers (Kevlar®) carbon fibers, glass fibers, Kapton®, silicones and silicone composites, etc., or metals.

For example, mention may thus be made of satellites, launchers or any component of such thereby coated satellites or launchers.

The coatings of the invention may be applied in one or several layers on the substrate to be painted, and their thickness may vary from a few micrometers to a few millimeters depending on the contemplated applications. Generally, the thickness per layer is advantageously comprised between 5 and 250 μm, with a surface electric resistance comprised between 1 and 1,000 MΩ/□.

The application of the coating layer of the invention on a substrate is accomplished as a paint film and may be carried out by manual mechanical spraying or automatic spraying with a paint gun, by a brush, a paintbrush, a stencil or by any other known technique.

If desired or required, a primary adherence layer or any other primary layer may be applied, for example an adherence or anti-corrosion primary layer, before applying the coating of the invention. More particularly, in the case of metal substrates, the adherence and anti-corrosion primaries MAPSIL® P255 red/clear, Alu-D, E′ and MAPSIL®SILICo, marketed by MAP may be applied. In the case of dielectric supports, adherence primaries (MAPSIL®P255 clear, Alu-D, Kapt A and E′ notably marketed by MAP) may be applied advantageously.

The following examples are given as an illustration and not as a limitation of the present invention.

### EXAMPLE 1

210 g of ZnO pigment doped with 2% Ga₂O₃ in a mixture of 363 g of hexamethyldisiloxane (DC200 Dow Corning) and of 121 g of octamethylcyclotetrasiloxane (tetramer D4 Bluestar Silicones) are mixed in 100 g of polydimethylsiloxane with silanol termination (DMS-S42 Gelest). This mixture A is milled with 794 g of balls for 3 mins. in a Red Devil ball mill. The obtained composition is separated from the balls by sifting. Moreover, the mixture B is prepared, consisting of 17 g of polydiethoxysiloxane (AB106292 ABCR), 23 g of methyltrimethoxysilane (AB111244 ABCR) and then of 0.16 g of tin dibutyldiacetate (8.20386 MERCK). A and B are mixed before application.

### EXAMPLE 2

286 g of ZnO pigment doped with 2% of Ga₂O₃, in a mixture of 450 g of hexamethyldisiloxane (DC200 Dow Corning) and of 150 g of octamethylcyclotetrasiloxane (tetramer D4 Bluestar Silicones) are mixed in 100 g of polydimethylsiloxane with silanol termination (DMS-S35 Gelest). This mixture A is milled with 986 g of balls for 3 mins. in a Red Devil ball mill. The obtained composition is separated from the balls by sifting. Moreover, the mixture B is prepared, consisting of 43 g of polydiethoxysiloxane (AB106292 ABCR) and of 0.3 g of tin dibutyldiacetate (8.20386 MERCK). A and B are mixed before application.

### EXAMPLE 3

300 g of ZnO pigment doped with 1.5% Ga₂O₃ in 215 g of solvents [octamethyltrisiloxane +n-heptane] are mixed in 100 g of polydimethylsiloxane with silanol termination (DNSS35). Moreover, 10 g of polydimethylsiloxane (AB106292 ABCR) and traces (<0.15 g) of the tin dibutyldiacetate (8.20386 MERCK) catalyst are mixed in 10 g of solvents [octamethyltrisiloxane+n-heptane]. The two thereby formed constituents are mixed just before application.

### EXAMPLE 4

The compositions of Examples 1 to 3 are applied under the following conditions:
substrate: AU4G for an adherence test, glass for measuring electric resistance, on Kapton (Examples 1 and 2) and on a silicone composite (Example 3) for alpha and epsilon measurements,
primary E′ according to the technical sheet of the manufacturer (Examples 1 and 2)
drying conditions: from 2 to 5 days at 20° C./50% RH

### EXAMPLE 5

The compositions according to Examples 1 to 3 above were tested for their thickness, adherence, absorptivity, emissivity and surface electric resistance. The results are summarized in the table below:

| | Example 1 | Example 2 | Example 3 |
|---|---|---|---|
| Paint thickness | 74 μm | 96 μm | 75 μm |
| Adherence | 0/5 | 0/5 | 0/5 |
| αp | 0.28 | 0.26 | 0.29 |
| εn | 0.91 | 0.91 | 0.91 |
| Rs | 20-30 MΩ/□ | 50-60 MΩ/□ | 15-45 MΩ/□ |

1. A composition comprising a base component and a hardener component;
wherein the base component comprises at least one pigment based on zinc oxide doped with gallium oxide, a binder of the silicon polymer type and a solvent of said binder; and
wherein the hardener component comprises at least one hardener.

2. The composition according to claim 1, wherein said binder is selected from the group consisting of silicon polymer resins.

3. The composition according to claim 1, wherein said binder is a polysiloxane having the formula R′₃SiO(R₂SiO)ₙSiR′₃ wherein R and R′ represent a group of the methyl, vinyl, phenyl, epoxy, hydroxyl, alkoxy, hydride or halogenated type, and n is a number from 1 to 10,000.

4. The composition according to claim 1 wherein the binder comprises a polydimethylsiloxane with a silanol termination.

5. The composition according to claim 1 wherein the at least one pigment comprises zinc oxide (ZnO) doped with Ga₂O₃.

6. The composition according to claim 1 wherein the base component and/or the hardener component further comprises a catalyst.

7. The composition according to claim 1 wherein the at least one hardener is selected from the group consisting of siloxane monomers, oligomers and polymers, mono-, di-, tri- or quadri-substituted with hydroxyl, alkoxy, hydride, epoxy or vinyl groups.

8. The composition according to claim 1 wherein the at least one hardener is a polysiloxane having the formula R′₃SiO(R₂SiO)ₙSiR′₃ wherein R and R′ may be a group of the methyl, vinyl, phenyl, epoxy, hydroxyl, alkoxy, hydride or halogenated type, and n is a number from 1 to 10,000.

9. The composition according to claim 1 wherein the hardener component further comprises a retardant and/or a solvent.

10. The composition according to claim 1 wherein the pigment:binder ratio is between 1 and 7 (by weight).

11. A method for preparing the composition according to claim 1 comprising:
preparing the base component by mixing the at least one pigment, the binder, and the solvent; and
preparing the hardener component by mixing the at least one hardener.

12. A method for preparing a coating comprising:
mixing a base component with a hardener component; wherein the base component comprises at least one pigment based on zinc oxide doped with gallium oxide, a binder of the silicon polymer type and a solvent of said binder; and wherein the hardener component comprises at least one hardener.

13. A coating obtained by the method according to claim 12.

14. The coating according to claim 13 wherein the coating has the following characteristics:
a solar absorptivity factor a of less than or equal to 0.3;
an infrared emissivity (c) greater than or equal to 0.8;
a surface electric resistance comprised between 1 and 1,000 MΩ/□ according to the ASTMD 257-97 or -98, -99 or ASTM D257-07 standard, as measured at atmospheric pressure or in a primary vacuum (10⁻³ torrs);
an adherence of class 0 or 1 out of 5 according to the NFEN ISO2409 standard (classification 30-038).

15. A substrate coated with the coating according to claim 13.

16. The substrate according to claim 15 wherein the substrate is selected from the group consisting of satellites, launchers and any component of such satellites or launchers.
